(19) United States
(12) Patent Application Publication
(10) Pub. No.: US 2007/0285687 A1
(43) Pub. Date: Dec. 13, 2007

(54) Image forming apparatus and image forming method

(75) Inventor: Hiroyuki Okuyama, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/452,058

(22) Filed: Jun. 13, 2006

(51) Int. Cl. G06F 15/00

(52) U.S. Cl. 358/1.9; 358/3.01

(57) ABSTRACT

An image forming apparatus according to the invention is characterized by including: a first input unit that inputs image data having attribute information and color information; a second input unit that inputs designated attribute information and designated color information designated by a user; a limited image generating unit that generates, when attribute information of a certain area in the image data and the designated attribute information coincide with each other and color information of the area and the designated color information coincide with each other, limited image data for limiting printing of the area from the image data; and an image recording unit that prints the limited image data. According to the image forming apparatus, it is possible to easily limit printing of a specific image designated in document data without changing the document data itself.

### BACKGROUND OF THE INVENTION

1. Field of the Invention

The present invention relates to an image forming apparatus and an image forming method, and, more particularly to an image forming apparatus and an image forming method for printing various document data.

2. Description of the Related Art

In creating an electronic document, a CAD drawing, or the like, characters or figures in a part of the document may be represented in colors. It is possible to highlight corrected parts, comments, and the like at the time of proofreading by using colors.

On the other hand, it is often desired not to print the corrected parts, the comments, and the like at the time of printing while leaving the corrected parts, the comments, and the like at the time of proofreading in data of the electronic document. In other words, there is also a strong need to limit printing of a part of areas of document information.

However, in the present situation, a function with which a user designates an image area that the user does not wish to print and limits printing of the area designated depends on document creation application software and image creation application software. The function is not realized as a function peculiar to a printer at the present point under the actual circumstances.

In an electronic document in which document areas that should be printed and document areas, printing of which is desired to be limited, are mixed, it is necessary to delete the document areas, printing of which is desired to be limited, using application software or the like.

Therefore, in particular, at a proofreading stage of a document, the user often performs repeated work, for example, deleting a part of the document at the time of printing and, when a printed document is inappropriate, restoring the deleted part of the document to an original state to continue editing. This imposes heavy burdens on the user. Since document data before editing cannot be restored easily, a procedure for storing and managing data before editing in advance is taken. This increases the burdens on the user.

### SUMMARY OF THE INVENTION

The invention has been devised in view of the circumstances and it is an object of the invention to provide an image forming apparatus and an image forming method that can easily limit printing of a designated specific image in document data without changing the document data itself.

In order to attain the object, an image forming apparatus according to an aspect of the invention is characterized by including: a first input unit that inputs image data having attribute information and color information; a second input unit that inputs designated attribute information and designated color information designated by a user; a limited image generating unit that generates, when attribute information of a certain area in the image data and the designated attribute information coincide with each other and color information of the area and the designated color information coincide with each other, limited image data for limiting printing of the area from the image data; and an image recording unit that prints the limited image data.

In order to attain the object, an image forming apparatus according to another aspect of the invention is characterized by including: a first input unit that inputs image data having attribute information and color information; a second input unit that inputs at least one of designated attribute information and designated color information designated by a user; a limited image generating unit that generates, when attribute information of a certain area in the image data and the designated attribute information coincide with each other or when color information of a certain area in the image data and the designated color information coincide with each other, limited image data for limiting printing of the area from the image data; and an image recording unit that prints the limited image data.

In order to attain the object, an image forming method according to another aspect of the invention is characterized by including: a first input step of inputting image data having attribute information and color information; a second input step of inputting designated attribute information and designated color information designated by a user; a limited image generating step of generating, when attribute information of a certain area in the image data and the designated attribute information coincide with each other and color information of the area and the designated color information coincide with each other, limited image data for limiting printing of the area from the image data; and an image recording step of printing the limited image data.

In order to attain the object, an image forming method according to another aspect of the invention is characterized by including: a first input step of inputting image data having attribute information and color information; a second input step of inputting at least one of designated attribute information and designated color information designated by a user; a limited image generating step of generating, when attribute information of a certain area in the image data and the designated attribute information coincide with each other or when color information of a certain area in the image data and the designated color information coincide with each other, limited image data for limiting printing of the area from the image data; and an image recording step of printing the limited image data.

### BRIEF DESCRIPTION OF THE DRAWINGS

In the accompanying drawings:

FIG. 1 is a diagram showing an example of an entire structure of an image forming apparatus according to an embodiment of the invention;

FIG. 2 is a diagram showing an example of a structure of a printer controller unit according to the embodiment;

FIG. 3 is a diagram showing an example of a structure of an image processing unit according to a first embodiment;

FIG. 4 is a flowchart showing an example of an image forming method according to the first embodiment;

FIGS. 5A and 5B are diagrams conceptually showing an effect of the embodiment;

FIG. 6 is a diagram showing an example of a structure of an image processing unit according to a second embodiment;

FIG. 7 is a flowchart showing an example of an image forming method according to the second embodiment; and

FIG. 8 is a diagram for explaining a concept of white color conversion according to the second embodiment.

### DETAILED DESCRIPTION OF THE EMBODIMENTS

Embodiments of an image forming apparatus and an image forming method according to the invention will be explained with reference to the accompanying drawings.

### (1) Structure of the Image Forming Apparatus

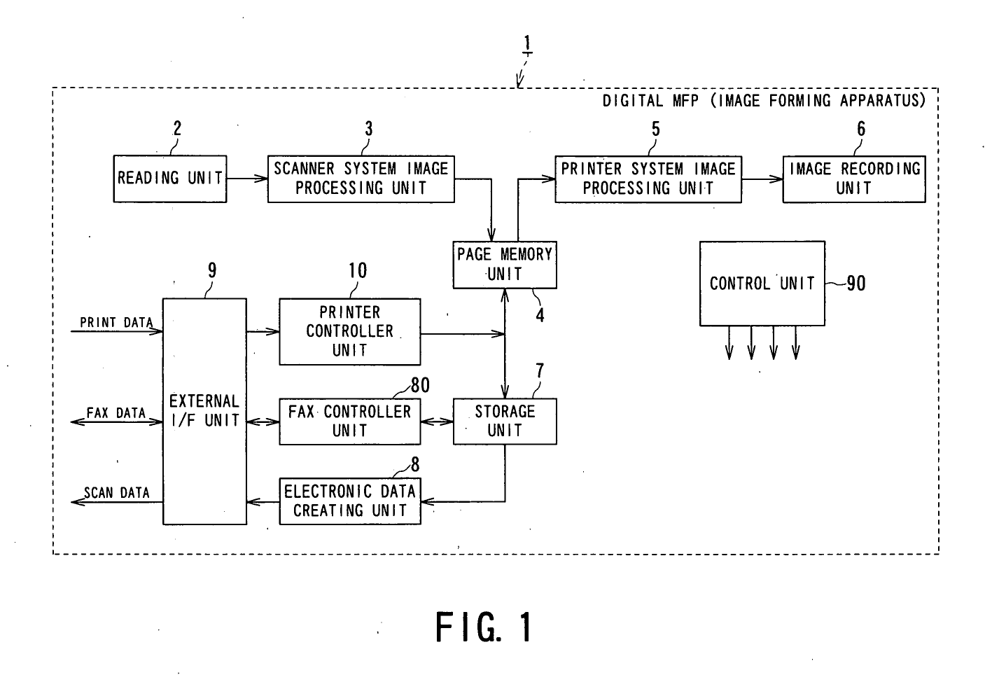

FIG. 1 is a diagram showing an example of a system structure of an image forming apparatus 1 that is an embodiment of the invention, for example, a digital MFP (Digital Multi-Function Peripheral).

This image forming apparatus 1 functions as a digital color multi-function peripheral. For example, a copy function, a printer function, a scanner function, a FAX function, a storage function, and the like are realized.

The image forming apparatus 1 includes a reading unit 2, a scanner system image processing unit 3, a page memory unit 4, a printer system image processing unit 5, and an image recording unit 6 and realizes the copy function with these components.

The reading unit 2 optically reads an original with, for example, a three-line CCD sensor and converts, the original into color digital image data of red (R), green (G), and blue (B).

The scanner system image processing unit 3 performs various kinds of image processing such as shading correction for correcting non-uniformity of a signal level in a main scanning direction and space filtering processing.

When the image forming apparatus 1 functions as the copy function, the image forming apparatus 1 converts three primary colors of R, G, and B into, for example, color signals of cyan (C), magenta (M), yellow (Y), and black (K) and outputs the color signals to the page memory unit 4. On the other hand, when the image forming apparatus 1 functions as the scanner function, the image forming apparatus 1 outputs the three primary colors of R, G, and B to the page memory unit 4.

The page memory unit 4 temporarily stores image data, for example, in page units and outputs the image data to the printer system image processing unit 5.

The printer system image processing unit 5 applies image processing for printing, for example, γ correction processing and gradation processing to the image data outputted from the page memory unit 4 and outputs the image data to the image recording unit 6.

The image recording unit 6 is a component that prints an image on a recording sheet in, for example, the electrophotographic system and includes an exposure device, a photosensitive drum, a developing device, and the like (all of which are not shown in the figure).

The image forming apparatus 1 includes a storage unit 7, an electronic data creating unit 8, an external I/F unit 9, a printer controller unit 10, and a FAX controller unit 80. These components are used to cause the image forming apparatus 1 to operate as the printer function, the scanner function, the FAX function, the storage function, or the like.

The storage unit 7 is constituted by, for example, an HDD (Hard Disk Drive) and stores image data read by the reading unit 2 and image data inputted from a personal computer or the like on the outside.

It is possible to read out the image data stored in the storage unit 7 as required and print the image data with the image recording unit 6 or output the image data to the outside as scan data.

In causing the image forming apparatus 1 to operate as the scanner function, the electronic data creating unit 8 converts image data into a predetermined data format to generate scan data. The scan data generated is outputted to the outside via the external I/F unit 9.

The FAX controller unit 80 causes the image forming apparatus 1 to operate as the FAX function. The FAX controller unit 80 converts image data read by the reading unit 2 into a data format for FAX and outputs the image data to a telephone line on the outside via the external I/F unit 9. The FAX controller unit 80 converts FAX data inputted from the telephone line into image data and serves the image data for printing in the image recording unit 6.

In causing the image forming apparatus 1 to operate as the printer function, the printer controller unit 10 performs various kinds of control and various kinds of processing required for the print function.

The control unit 90 performs control for the entire image forming apparatus 1.

Image processing according to the invention is image processing of content related to the print function and is realized mainly by the printer controller unit 10. Thus, in the following description, a detailed structure of the printer controller unit 10 and operations thereof will be explained.

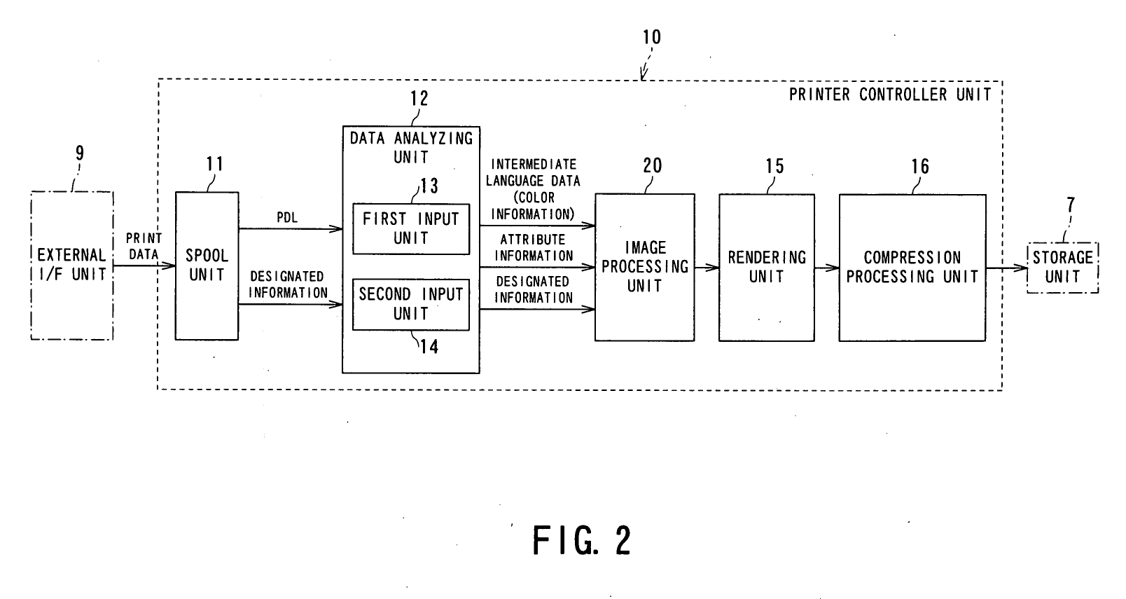

FIG. 2 is a diagram showing an example of the detailed structure of the printer controller unit 10.

The printer controller unit 10 includes a spool unit 11, a data analyzing unit 12, an image processing unit 20, a rendering unit 15, and a compression processing unit 16.

Print data inputted from an external apparatus such as a personal computer is inputted to the printer controller unit 10 via the external I/F unit 9 and temporarily stored in the spool unit 11.

The print data is usually inputted from the external apparatus in a form of page description language (PDL) data. This page description language is inputted to a first input unit 13 of the data analyzing unit 12.

The data analyzing unit 12 of the printer controller unit 10 analyzes a language described in the PDL and generates attribute information and intermediate language data forming a pair with the attribute information.

The attribute information is information indicating a type of an object in a document and a position of the object. The object indicates a type of an element of document data and is, for example, a “character object”, a “graphic object”, an “image object”, and the like. The intermediate language data is data mainly indicating color information and is, for example, information indicating respective levels of red (R), green (G), and blue (B) with values in a range of 0 to 255, respectively.

On the other hand, in this embodiment, “designated information” is also inputted as print data. The designated information is, for example, information set by the user for a printer driver installed in a personal computer serving as an external apparatus. The designated information is inputted from the external apparatus via the external I/F unit 9, temporarily stored in the spool unit 11 of the printer controller unit 10, and, then, inputted to the second input unit 14 of the data analyzing unit 12.

The designated information is information including designated object information and designated color information.

When the user designates a specific object and a specific color in document data, the user can limit printing (prevent printing) of an area of the document data corresponding to the object designated and the color designated.

Therefore, when the user intends to limit printing of a red character included in the document data, the user designates the “character object” as a designated object and designates “red” as designated color information.

These intermediate language data, the attribute information, and the designated information are inputted to the image processing unit 20 from the data analyzing unit 12.

The image processing unit 20 mainly performs color conversion processing. In general, color information inputted from the personal computer or the like is in a form of three primary color data of R, G, and B (first color image data). The image processing unit 20 converts the three primary color data into color data for printing (second color image data), for example, four color data of cyan (C), magenta (M), yellow (Y), and black (K) for each object.

In this embodiment, as described later, the image processing unit 20 generates limited image data for limiting printing as second color image data.

The second color image data generated by the image processing unit 20 is converted into so-called raster image data (data represented by arrangement of colored dots) in the rendering unit 15 at the next stage.

This raster image data is subjected to data compression by the compression processing unit 16 and temporarily stored in the storage unit 7. Thereafter, the raster image data is transferred to the printer system signal processing unit 5 (see FIG. 1) via the page memory unit 4, restored to the original raster image data (data expansion) in the printer system signal processing unit 5, and subjected to image processing for printing such as gradation processing.

Finally, in the image recording unit 6, a print image is formed on a recording medium such as a recording sheet.

### (2) First Embodiment

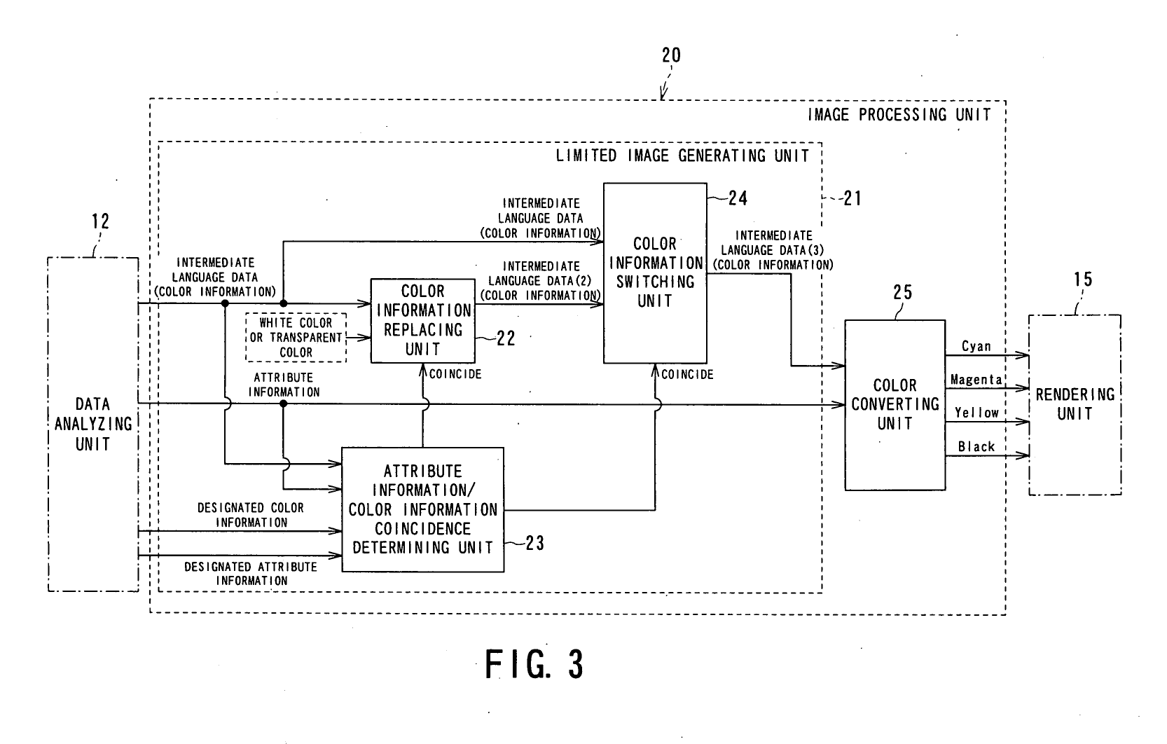

FIG. 3 is a diagram showing an example of a constitution of the image processing unit 20 according to a first embodiment. The image processing unit 20 includes a limited image generating unit (limited image generating means) 21 that generates a limited image, which is a point of the invention, and a color converting unit (color converting means) 25.

The limited image generating unit 21 includes a color information replacing unit (color information replacing means) 22, an attribute information/color information coincidence determining unit (attribute information/color information coincidence determining means) 23, and a color information switching unit (color information switching means) 24.

The attribute information/color information coincidence determining unit 23 performs collation determination for attribute information and designated attribute information of image data outputted from the data analyzing unit 12 and also performs collation determination for intermediate language data (color information) and designated color information. The attribute information/color information coincidence determining unit 23 outputs, when the attribute information (an object) and the designated attribute information (a designated object) coincide with each other and the intermediate language data (color information) and the designated color information coincide with each other, information indicating the “coincidence” to the color information replacing unit 22 and the color information switching unit 24. The attribute information/color information coincidence determining unit 23 outputs the designated object and the designated color information to the color information replacing unit 22 and the color information switching unit 24, respectively, together with the “coincidence” information.

The coincidence determination for the intermediate language data (color information) and the designated color information may take a form for determining whether the intermediate language data (color information) is included in a predetermined width around the designated color information rather than strict coincidence determination.

The color information replacing unit 22 replaces a color of an area of an object determined as coinciding with the designated object and the designated color information among the intermediate language data (color information) with a “white color” or a “transparent color” to generate intermediate language data (2) (color information).

For example, when the designated object is a “character object” and the designated color information is a “red color”, the color information replacing unit 22 generates the intermediate language data (2) (color information) obtained by replacing a red character with a white character or replacing a red character with a character of a transparent color.

The color information switching unit 24 performs switching processing for outputting one of the intermediate language data (color information) and the intermediate language data (2) (color information) to the color converting unit 25 at the post stage.

When the designated object or the designated color information is not included in the image data outputted from the data analyzing unit 12 (determination of “non-coincidence”), the intermediate language data (color information) and the attribute information outputted from the data analyzing unit 12 are directly outputted to the color converting unit 25.

On the other hand, when the determination of the attribute information/color information coincidence determining unit 23 is “coincidence”, image data obtained by replacing a color of the pertinent object with a “white color” or a “transparent color” is outputted to the color converting unit 25.

For example, when the designated object is a character object and the designated color information is a red color, the red color (R, G, B=255, 0, 0) in the character object in the image data is replaced with a white color (R, G, B=255, 255, 255) or a transparent color “transparency”.

In the constitution described above, the color information switching unit 24 switches and outputs a replaced image obtained by replacing a specific object with a white color or a transparent color and an image before replacement. However, the color information replacing unit 22 and the color information switching unit 24 may be constituted as one color information replacing unit. In this case, this color information replacing unit replaces, only when the determination is “coincidence”, a color of the pertinent object with a white color or a transparent color with respect to the intermediate language data inputted and outputs the color to the color converting unit 25.

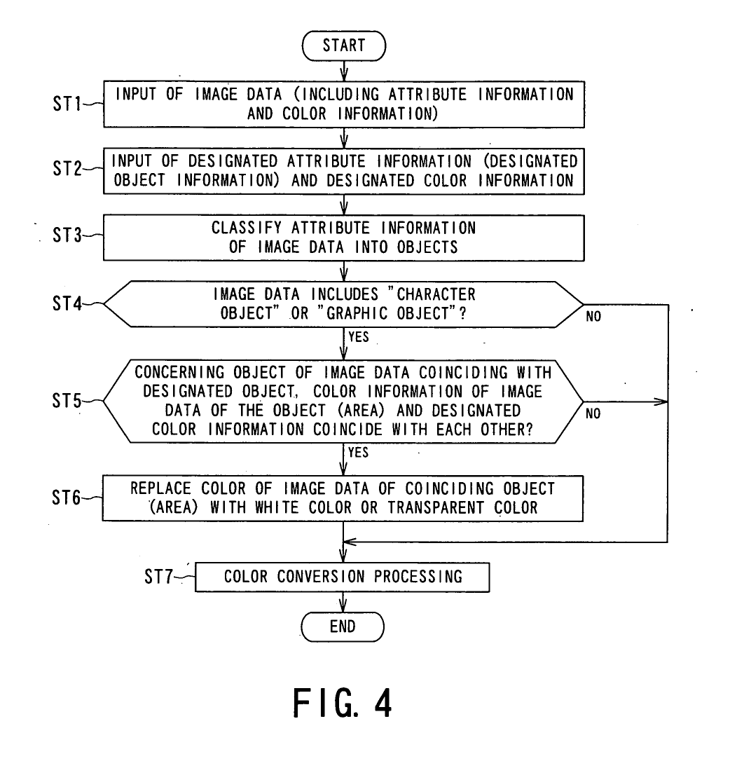

FIG. 4 is a flowchart showing an image forming method according to this embodiment, in particular, processing of a limited image generating method.

First, in step ST1, the printer controller unit 10 inputs image data (including attribute information and color information) described in the PDL from the personal computer or the like on the outside via the external I/F unit 9.

Similarly, the printer controller unit 10 inputs designated attribute information and designated color information set for the printer driver or the like by the user via the external I/F unit 9 (step ST2).

Subsequently, the printer controller unit 10 classifies the attribute information of the image data inputted into objects (step ST3).

In step ST4, the print controller unit 10 performs processing for excluding objects other than a “character object” and a “graphic object”, for example, an “image object” such as a photograph from objects to be determined. It is possible to limit printing of a specific color with respect to the “image object”. However, this may result in an unnatural image. It is also considered that an object for which the user usually whishes to limit printing is often a character or graphics. Thus, in step ST4, objects other than the “character object” and the “graphic object” are excluded from an object of processing. Usual color conversion processing is applied to the excluded objects in step ST7.

In step ST5, coincidence determination of the attribute information and the color information is performed. Concerning an object in the image data coinciding with a designated object, it is further determined whether color information of the object and the designated color information coincide with each other to determine an object to be processed. When the attribute information or the color information does not coincide with the designated attribute information or the designated color information (when it is determined that the object is not an object to be processed), the printer controller unit 10 proceeds to step ST7 and performs the usual color conversion processing.

In step ST6, the printer controller unit 10 replaces a color of an object determined to be processed with a white color or a transparent color.

In step ST7, the usual color conversion processing is performed. For example, the printer controller unit 10 generates printing image data of four colors of C, M, Y, and K using a three-dimensional color conversion table constituted by grids of 17×17×17 points with respect to respective signals of R, G, and B inputted.

At this point, since the color of the object to be processed is replaced with the white color or the transparent color, substantial color conversion is not performed and an area of the object to be processed in not printed.

According to the processing described above, printing of an object designated by the user and an object corresponding to a color designated by the user is limited (is not printed)

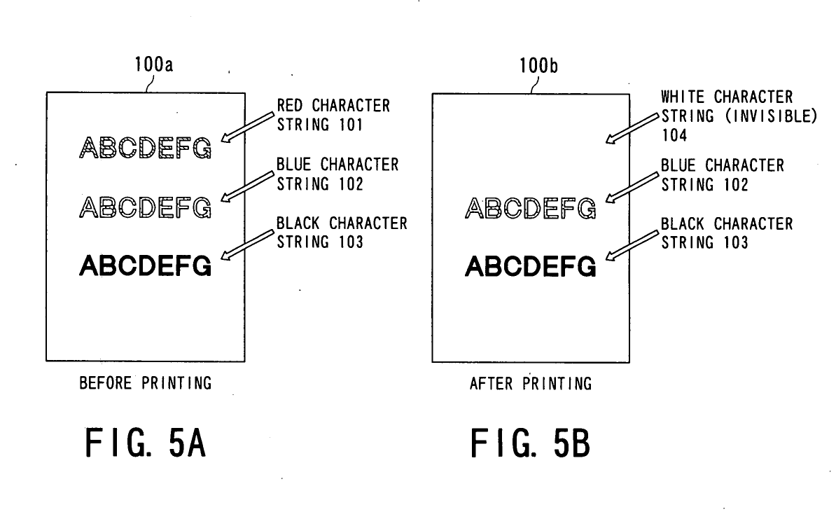

FIG. 5 is a diagram for explaining an effect of this embodiment. FIG. 5A is a diagram showing image data 100a before printing, that is, before processing. The image data 100a has, for example, respective character objects 101, 102, and 103 of a red color, a blue color, and a black color (objects indicated by “ABCDEFG” in the figure). FIG. 5B shows a result obtained by printing image data 100b after processing. When the user designates a character object as a designated object not desired to be printed and designates a red color as a designated color not desired to be printed, only a red character string 101 is replaced with a white character string 104. Since the white character string is invisible, the white character string is not substantially printed.

According to the image forming apparatus 1 and the image forming method according to the first embodiment, it is possible to easily limit printing of a specific image (a specific object and a specific color) in document data simply by designating an object and a color without changing the document data itself using application software for document creation.

### (3) Second Embodiment

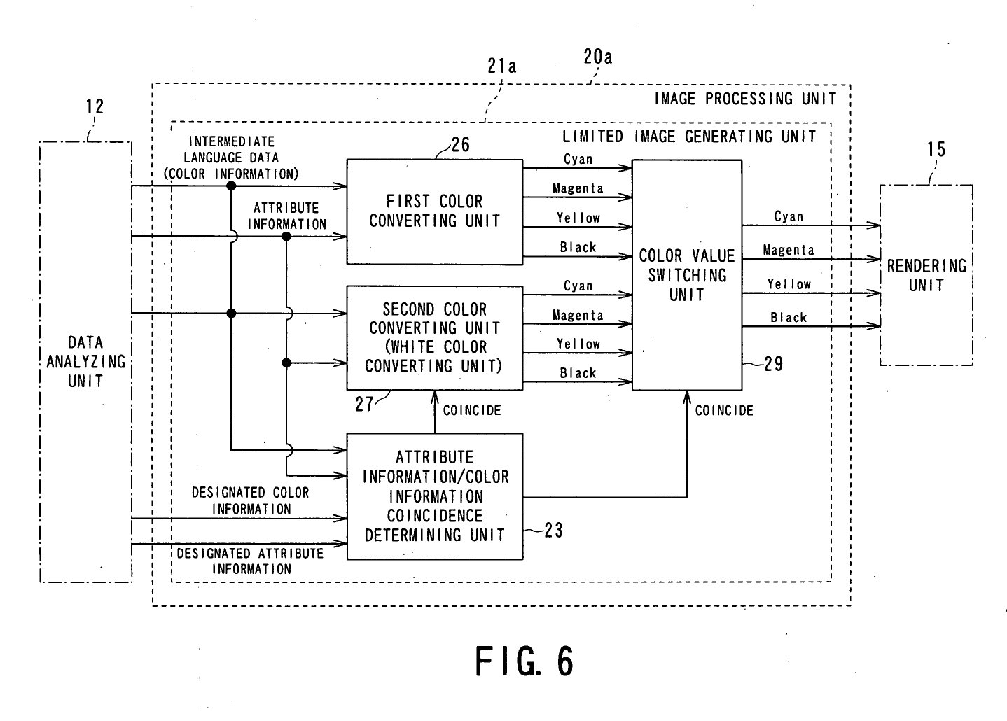

FIG. 6 is a diagram showing an example of a structure of an image processing unit 20a and a limited image generating unit (limited image generating means) 21a according to a second embodiment. In this embodiment, the image processing unit 20a and the limited image generating unit 21a have the same structure. The image processing unit 20a and the limited image generating unit 21a will be hereinafter explained as the limited image generating unit 21a.

The limited image generating unit 21a according to the second embodiment includes a first color converting unit (first color converting means) 26, a second color converting unit (second color converting means) 27, an attribute information/color information coincidence determining unit 23, and a color value switching unit 29.

The first color converting unit 26 is a section that performs the usual color conversion processing. The first color converting unit 26 converts first color image data of R, G, B, and the like, which is color information of intermediate language data, into second color data for printing of C, Y, Y, K, and the like.

On the other hand, the second color converting unit 27 converts a color of an object determined as an object to be processed among objects in a document into a white color (outputs values of C, M, Y, and K forming a white color. This color conversion may be referred to as white color conversion.). The second color converting unit 27 applies the usual color conversion processing to objects other than the object to be processed.

The object to be processed is, as in the first embodiment, an object for which it is determined by the attribute information/color information coincidence determining unit 23 that attribute information (an object) in image data and designated attribute information (a designated object) coincide with each other and color information thereof and designated color information coincide with each other.

The color value switching unit 29 switches second color image data outputted from the first color conversion unit 26 and second color image data outputted from the second color converting unit 27 and outputs the switched second color image data to the rendering unit 15. This switching is performed on the basis of “incidence” information outputted from the attribute information/color information coincidence determining unit 23.

In the structure shown in FIG. 6, the three components, namely, the first color converting unit 26, the second color converting unit 27, and the color value switching unit 29 may be integrated as one “color converting unit (color converting means)”. In this case, concerning an object to be processed, this “color converting unit” converts a color of the object into a white color regardless of an original color of the object and applies the usual color conversion processing to objects other than the object to be processed.

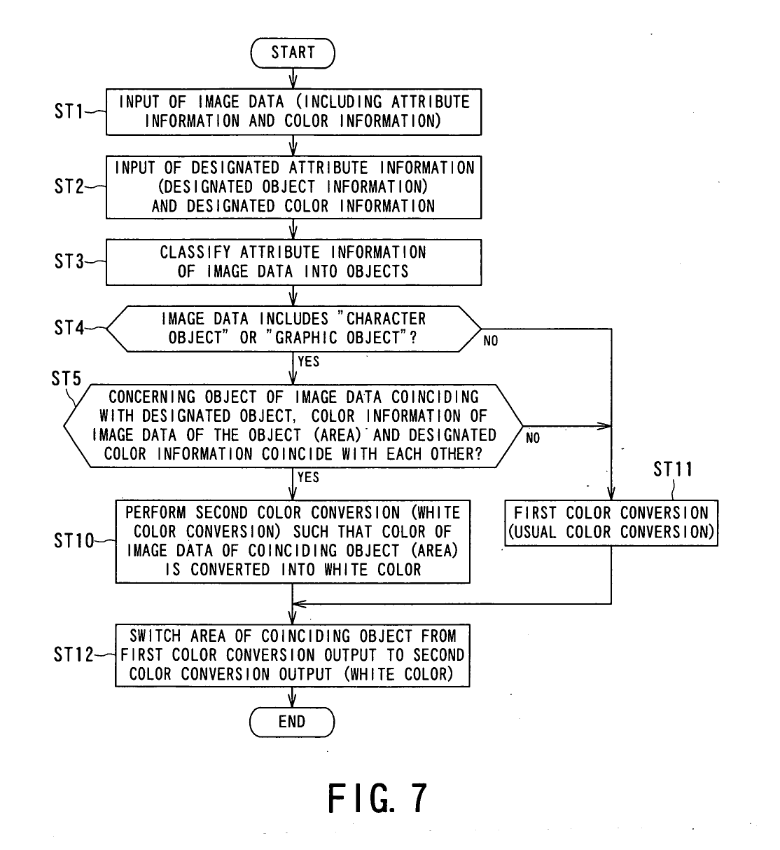

FIG. 7 is a flowchart showing an example of processing of an image forming method according to the second embodiment, in particular, a limited image generating method.

The image forming method according to the second embodiment is different from that according to the first embodiment (FIG. 4) in steps ST10, ST11, and ST12.

Step ST10 is processing performed in the second color converting unit 27. In step ST10, a color of an object to be processed is converted into a white color and the usual color conversion processing is applied to objects other than the object to be processed to generate second color image data.

Step ST11 is processing performed in the first color converting unit 26. In step ST11, the usual color converting processing is performed to generate second color image data.

In step ST12, these two second color image data are switched on the basis of “coincidence” information from the attribute information/color information coincidence determining unit 23.

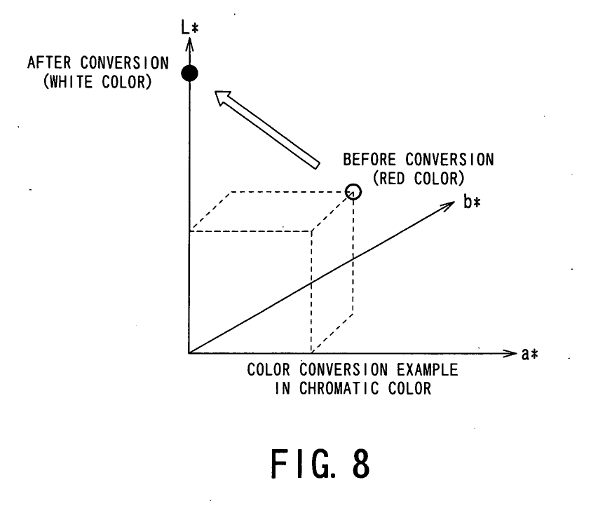

FIG. 8 is a diagram for explaining a concept of white color conversion according to the second embodiment. FIG. 8 is a graph representing a color space of a color image with a CIELAB color space. An L* axis represents brightness and an a* axis and a b* axis represent a hue and a chroma.

An achromatic color is located on the L* axis and a chromatic color is located in an area other than the L* axis. FIG. 8 indicates a concept of white color conversion performed by the second color converting unit 27 when a red color, which is a chromatic color, is designated as a designated color. According to this white color conversion, the red color before conversion is converted from a position indicated by a white circle to a position of a white color indicated by a black circle on the L* axis (actually, a position near a maximum value in a plus direction on the L* axis) in FIG. 8.

In the second embodiment, as in the first embodiment, it is possible to easily limit printing of a specific image (a specific object and a specific color) in document data simply by designating an object and a color without changing the document data itself using application software for document creation.

In the above explanation, the replacement of the white color or the white color conversion is performed when the object in the image data and the designated object coincide with each other and the color information of the object and the designated color information coincide with each other. However, one of the object and the color information may be designated as designated information.

In this form, for example, when a red color is present only in a small part of image data and it is not desired to print this red color, the color information (the red color) only has to be designated, thus, operation is simplified.

When it is desired to limit only printing of characters in an image in which most of image data is a photograph (an image object) and a character object is included in a small part thereof, the object (the character object) only has to be designated.

On the other hand, plural objects and plural colors may be designated as designated information. In this case, for example, it is possible to limit printing of the plural objects and the plural colors such as a red character and a green figure (graphic object).

Moreover, it is also possible to limit printing for a color of a delicate hue and a complicated mixed color by giving latitude to designated color information (a level value of a designated color).

Besides, it is also possible to limit printing for image data of a gray level in a specific range by including an achromatic color as a designated color.

The invention is not limited to the embodiments themselves. At an implementation stage, it is possible to modify and embody the elements without departing from the spirit of the invention. It is possible to form various inventions according to appropriate combinations of the plural elements disclosed in the embodiments. For example, some elements may be deleted from all the elements described in the embodiments. Moreover, elements in different embodiments may be appropriately combined.

What is claimed is:

1. An image forming apparatus comprising:
a first input unit configured to input image data having attribute information and color information;
a second input unit configured to input designated attribute information and designated color information designated by a user;
a limited image generating unit configured to generate, when the attribute information of an area in the image data and the designated attribute information coincide with each other and the color information of the area and the designated color information coincide with each other, a limited image data for limiting printing of the area from the image data; and
an image recording unit configured to print the limited image data.

2. An image forming apparatus according to claim 1, wherein the limited image generating unit classifies the attribute information inputted from the first inputting unit into at least a character object, a graphic object, and an image object and, when the designated attribute information is the character object or the graphic object, determines whether the attribute information of the image data and the designated attribute information coincide with each other.

3. An image forming apparatus according to claim 1, wherein the limited image generating unit replaces, when the attribute information of the area in the image data and the designated attribute information coincide with each other and the color information of the area and the designated color information coincide with each other, a color of the image data of the area with a white color to generate the limited image data.

4. An image forming apparatus according to claim 1, wherein the limited image generating unit replaces, when the attribute information of the area in the image data and the designated attribute information coincide with each other and the color information of the area and the designated color information coincide with each other, a color of the image data of the area with a transparent color to generate the limited image data.

5. An image forming apparatus according to claim 1, wherein
the limited image generating unit includes a color converting unit configured to convert a first color image-data corresponding to the color information of the image data into a second color image data, and
the color converting unit converts, when the attribute information of the area in the image data and the designated attribute information coincide with each other and the color information of the area and the designated color information coincide with each other, a color of the second color image data of the area into a white color regardless of a color of the first color image data.

6. An image forming apparatus comprising:
a first input unit configured to input image data having-attribute information and color information;
a second input unit configured to input at least one of designated attribute information and designated color information designated by a user;
a limited image generating unit configured to generate, when the attribute information of an area in the image data and the designated attribute information coincide with each other or when the color information of the area in the image data and the designated color information coincide with each other, a limited image data for limiting printing of the area from the image data; and
an image recording unit configured to print the limited image data.

7. An image forming apparatus comprising:
first input means for inputting image data having attribute information and color information;
second input means for inputting designated attribute information and designated color information designated by a user;
limited image generating means for generating, when the attribute information of an area in the image data and the designated attribute information coincide with each other and the color information of the area and the designated color information coincide with each other, a limited image data for limiting printing of the area from the image data; and
image recording means for printing the limited image data.

8. An image forming apparatus according to claim 7, wherein the limited image generating means classifies the attribute information inputted from the first inputting means into at least a character object, a graphic object, and an image object and, when the designated attribute information is the character object or the graphic object, determines whether the attribute information of the image data and the designated attribute information coincide with each other.

9. An image forming apparatus according to claim 7, wherein the limited image generating means replaces, when the attribute information of the area in the image data and the designated attribute information coincide with each other and the color information of the area and the designated color information coincide with each other, a color of the image data of the area with a white color to generate the limited image data.

10. An image forming apparatus according to claim 7, wherein the limited image generating means replaces, when the attribute information of the area in the image data and the designated attribute information coincide with each other and the color information of the area and the designated color information coincide with each other, a color of the image data of the area with a transparent color to generate the limited image data.

11. An image forming apparatus according to claim 7, wherein
the limited image generating means includes a color converting means for converting a first color image data corresponding to the color information of the image data into a second color image data, and
the color converting means converts, when the attribute information of the area in the image data and the designated attribute information coincide with each other and the color information of the area and the designated color information coincide with each other, a color of the second color image data of the area into a white color regardless of a color of the first color image data.

12. An image forming method comprising the steps of:
first inputting image data having attribute information and color information;
second inputting designated attribute information and designated color information designated by a user;
generating, when the attribute information of an area of the image data and the designated attribute information coincide with each other and the color information of the area and the designated color information coincide with each other, a limited image data for limiting printing of the area from the image data; and
printing the limited image data.

13. An image forming method according to claim 12, wherein, in the limited image generating step, the attribute information inputted in the first inputting step is classified into at least a character object, a graphic object, and an image object and, when the designated attribute information is the character object or the graphic object, it is determined whether the attribute information of the image data and the designated attribute information coincide with each other.

14. An image forming method according to claim 12, wherein, in the limited image generating step, when the attribute information of the area in the image data and the designated attribute information coincide with each other and the color information of the area and the designated color information coincide with each other, a color of the image data of the area is replaced with a white color to generate the limited image data.

15. An image forming method according to claim 12, wherein, in the limited image generating step, when the attribute information of the area in the image data and the designated attribute information coincide with each other and the color information of the area and the designated color information coincide with each other, a color of the image data of the area is replaced with a transparent color to generate the limited image data.

16. An image forming method according to claim 12, wherein
the limited image generating step includes a step of converting a first color image data corresponding to the color information of the image data into a second color image data, and
in the color converting step, when the attribute information of the area in the image data and the designated attribute information coincide with each other and the color information of the area and the designated color information coincide with each other, a color of the second color image data of the area is converted into a white color regardless of a color of the first color image data.

17. An image forming method comprising the steps of:
first inputting image data having attribute information and color information;
second inputting at least one of designated attribute information and designated color information designated by a user;
generating, when the attribute information of an area in the image data and the designated attribute information coincide with each other or when the color information of the area in the image data and the designated color information coincide with each other, a limited image data for limiting printing of the area from the image data; and
printing the limited image data.
